(19) United States
(12) Patent Application Publication
(10) Pub. No.: US 2003/0100971 A1
(43) Pub. Date: May 29, 2003

(54) Method of managing manufacturing machine

(76) Inventor: Mao-Shing Sun, Taipei (TW)

Correspondence Address: J.C. Patents, Inc., Suite 250, 4 Venture, Irvine, CA, 92613, US

(21) Appl. No.: 10/078,028

(22) Filed: Feb. 15, 2002

(30) Foreign Application Priority Data
Nov. 27, 2001 (TW) 90129242

(51) Int. Cl. G06F 19/00

(52) U.S. Cl. 700/108; 707/104.1; 700/174

(57) ABSTRACT

A method of managing a manufacturing machine is disclosed. The machine is checked to confirm whether the machine is in available or non-available status. If the machine is in non-available status, then the type of the non-available status is determined. The reason why the machine is placed into the type of the non-available status is checked. Then, the type of the non-available status is recorded together with the reason thereof. The reason is selected for a plurality of reason codes which are previously determined. If the machine is in available status, then the type of the available status is determined and recorded.

### CROSS-REFERENCE TO RELATED APPLICATION

This application claims the priority benefit of Taiwan application serial no. 90129242, filed Nov. 27, 2001.

### BACKGROUND OF THE INVENTION

1. Field of the Invention

The present invention relates to a shop-floor management system. More specifically, the present invention relates to a management system which can provide information, including available and non-available statuses, on all the manufacturing machines in a semiconductor manufacturing plant to find out the reason why the machine has been placed into non-available status.

2. Description of the Related Art

In the current semiconductor manufacturing process, many procedures are required, such as epitaxial silicon growth, deposition, photolithography, etching, and interconnection. Accordingly, there are many manufacturing machines required for these procedures in a FAB. A wafer is obtained through the above-mentioned procedures. The manufacturing machines have such high precision that it is best to provide a shop-floor managing employee with enough information about the manufacturing machine to effectively control the whole manufacturing process and the yield.

Roughly, the manufacturing machine used in the FAB is either in available status or non-available status. The available status of the manufacturing machine means the machine is working at the present moment. The non-available status of the machine means the machine is in idle, in broken-down, in repair or in maintenance status. The shop-floor managing employee has to record various statuses of the machine at any given time in order to build a list. In the case of a machine in non-available status (hereinafter, non-available machine), the shop-floor management system or software only records the status of the machine that is not working at the present moment, without any information about the reason why the machine is not working.

For example, when the etching machine is in need of repair, the shop-floor or equipment operator only records that the machine is in repair, i.e. non-available status. The reason why the machine is in need of repair can not be found. When an etching machine is in idle status, the shop-floor or equipment operator only records that the machine is idle status without any information about the reason. There are various reasons why a machine is in need of repair or maintenance. For example, the machine may break down due to particles generated during the manufacturing process or by the operator' carelessness. Further, a non-skillful operator may delay a next procedure.

A conventional management system only records the machine status in the ENG column of FIG. 1. However, management can not find out why the machine, for example No. 4, SEM09, remains in non-available status longer than other machines.

Therefore, in the conventional management system, the management employee or production line operator is provided with only the status information of the machines, available status or non-available status. However, such information is not sufficient for an operator or employee to increase the production efficiency or the yield. In order to realize the causes of the non-available status for each machine and more effectively control the machines, more information should be recorded and organized.

### SUMMARY OF THE INVENTION

In one aspect of the present invention, a shop-floor management system and a method thereof are provided. In the present invention, a reason why a machine SEM09 remains in REG.R-C120 status longer than other machines can be found by setting up a reason code database.

In another aspect of the present invention, a shop-floor management system and a method thereof are provided, in which not only the status of the machine but also the reason code thereof are recorded, whereby the machine can be controlled more precisely.

In still another aspect of the present invention, a shop-floor management system and a method thereof are provided, in which the status change and the change reason for each machine can be recorded in more detail, thereby a managing employee can easily control and smoothly handle the machine.

In order to achieve the above and other objects of the present invention, a shop-floor management system is provided. First, a test is made to determine if the machine is available or non-available. When the machine is non-available, a test is made to determine the type of the non-available status. Then, the reason for non-available status is detected. Both the type and reason of the non-available status are recorded. The reason is recorded by selecting from a plurality of reason codes. Further, the reason codes can be previously determined. When the machine is in available status, a type of available status is determined and then recorded.

The present invention further provides a shop-floor management system. First, a reason list including a plurality of reason codes is built. A test is made to determine if the machine is available or non-available. When the machine is non-available, the type of non-available status is recorded. Then, the reason of non-available status is detected and corresponded to one of reason codes previously determined. The type and the reason code of the non-available status are recorded. A new reason is added into the reason code list once the new code is generated. When the machine is in available status, the type of available status is determined and then recorded.

The present invention further provides a shop-floor management system, in which a plurality of machines are managed by using a database. The system of the present invention includes a reason database, a machine database and a user/manager interface. The reason database has a plurality of reason codes corresponding to each respective non-available reason for each machine. The machine database records the status of each machine. The columns in the machine database include one for type of the machine, one for type of the non-available status and one for the reason code selected from the reason code database. A user interface is provided, which couples the reason code database to the machine database, allowing a user to access the machine database. The reason codes in the reason code database are previously determined. A manager interface is further provided to connect with the reason code database for updating the reason code database. The above-mentioned user interface can be a graphic user interface.

### BRIEF DESCRIPTION OF THE DRAWINGS

It is to be understood that both the foregoing general description and the following detailed description are exemplary, and are intended to provide further explanation of the invention as claimed.

The accompanying drawings are included to provide a further understanding of the invention, and are incorporated in and constitute a part of this specification. The drawings illustrate embodiments of the invention and, together with the description, serve to explain the principle of the invention. In the drawings,

FIG. 1 shows a record list of machine statuses;

FIG. 2 is a schematic view of a shop-floor management system according to one preferred embodiment of the present invention;

FIG. 3 is a flow chart of a shop-floor management system according to one preferred embodiment of the present invention;

FIGS. 4A to 4D illustrates an exemplary method of a shop-floor management system according to one preferred embodiment of the present invention.

### DESCRIPTION OF THE PREFERRED EMBODIMENT

Reference will now be made in detail to the present preferred embodiments of the invention, examples of which are illustrated in the accompanying drawings. Whenever possible, the same reference numbers are used in the drawings and the description to refer to the same or like parts.

In the present invention, not only is the type of non-available status of a manufacturing machine recorded, but also the reason thereof.

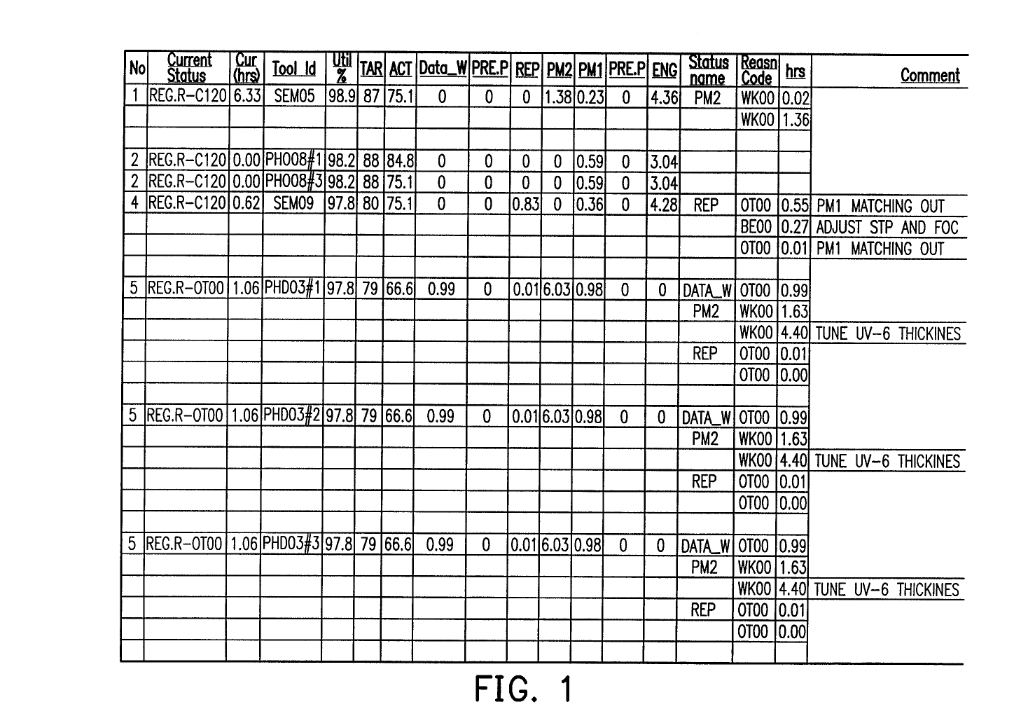

As shown in FIG. 1, various records are listed, such as current status, current hours (cur_hrs), machine number (tool_id), utility percentage (util(%)). These records are commonly used in the prior art, therefore, description thereof can be omitted. In the present invention, the reasons for the various types of status for each machine are recorded into the list of FIG. 1 as respective reason codes, together with the timing records. Thereby, an operator can realize the actual situation of the machine from this list.

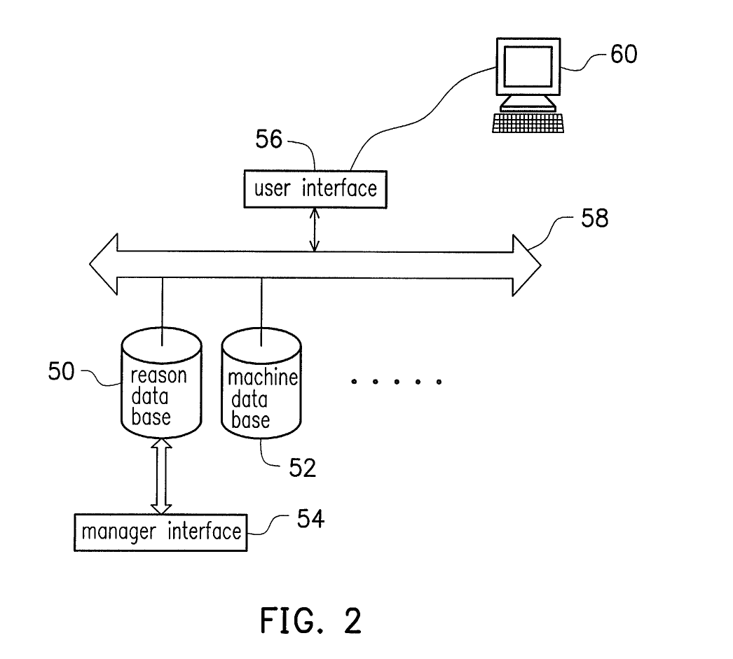

FIG. 2 is a schematic view of a shop-floor management system according to one preferred embodiment of the present invention. The management system of the present invention mainly consists of a reason database 50 and a machine database 52. The reason database 50 is coupled to the machine database via a bus 58 and a user interface 56. The reason database contains various reason codes, especially for a non-available machine, including idle reason codes and broken-down reason codes. The break-down of the machine may be caused from particles, operational errors or conveying. The reason code can be selected from a previously built reason list. The reason list is built by means of recording various reasons, that often occur in practice, by the shop-floor managing employee or a production line operator/engineer. Because there are so many machines used in the manufacturing process, some situations, which do not often occur in practice, may not appear in the record. In such case, the production line operator, the engineer, the shop-floor managing employee or a supervisor first analyzes the reason why the new situation occurs and then a system managing employee adds a new reason code corresponding to the reason why the new situation occurs into the list.

When the new reason code is generated, the managing employee can add the new reason code into the reason code database 50 via the user interface 56. In consideration of the stability of the whole system, the reason code database 50 can only be changed by an authorized person. For example, the authorized person should enter a password before changing the reason code database 50 via the user interface 56. Alternatively, as shown in FIG. 2, a manager interface can be further provided for a manager to access the reason code database 50.

The user interface 56 can be a graphic user interface. Thereby, the user can access, input or output the information in the system by clicking. The user interface 56 can be connected to a display device, such as a personal computer 60. The machine database 52 includes at least a machine mode (or machine number), a type of the non-available status, and a reason code. A start time point can be optionally included.

The machine database 52 includes all information about status, time, and reason code of the machine. The user or the manager can immediately realize the condition of the machine, and make a best decision to deal with the condition.

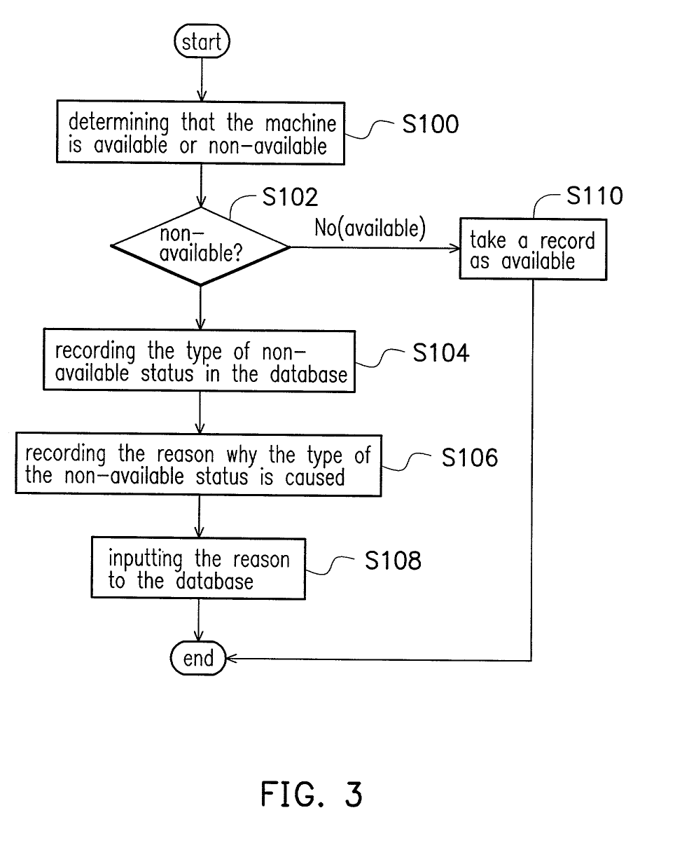

FIG. 3 is a flow chart of a shop-floor management system according to one preferred embodiment of the present invention.

First, in step S100, a test is made to determine if the machine is available or non-available. When the machine is in broken-down, idle or in maintenance status, the machine is non-available. Once the machine is non-available, the whole manufacturing process and the throughput thereof are seriously affected.

In step S102, the machine is detected to see if the machine is non-available. The present invention aims at finding out the reason why the machine has been placed into non-available status, and thus preventing the machine from being placed into non-available status.

There are many reasons why the machine is placed into non-available status, such as machine defects, operational errors of the machine, or poor connection between machines or processes. In the case of an etching machine, particles, if any, generated during the etching may pollute the machine and interfere with the operation of the machine. Therefore, the machine has to be broken down to check or clean the particles. Once the machine is broken down, the machine is placed into non-available status.

If the machine is detected to be in non-available status in the step S102, then go to step S104. In step S104, the type of non-available status of the machine is recorded, for example, in a database to show the machine is in idle, maintenance or broken-down status. The type of non-available status of the machine can be entered in the database of the computer by a supervisor, a shop-floor managing employee, or a production line operator.

Then go to step S106. In the step S106, the reason why the machine is placed into the type of non-available status recited above is recorded. The reason is selected from a reason list which has been previously built. The reason list includes a plurality of different reason codes. Each reason code represents a reason why the machine is placed into a kind of situation, such as maintenance, particle destroy, operational errors and the like. The reason list is built by means of recording various reasons, which often occur in practice, by the shop-floor managing employee or a production line operator/engineer.

Because there are so many machines used in the manufacturing process, some situations, which do not often occur in practice, may not appear in the record. In such a case, the production line operator, the process engineer, the shop-floor managing employee or a supervisor first analyzes the reason why the new situation occurred, and then a system managing employee adds a new reason code, corresponding to the reason why the new situation occurs, into the list.

Although the list is previously built, it can be changed dynamically. That is, when a new reason code is generated, the system manager can revise the content of the list any time.

Then go to step S108. A reason code, corresponding to the reason why the machine is placed into non-available status, is selected from the list. In the case of the etching machine in maintenance status, the information of maintenance status, which is one kind of non-available status, is recorded in the database. Further, if the machine is broken down because of the particles generated during etching, then that reason is recorded. If the machine is placed into idle or broken-down status because of operational errors, then that reason is recorded.

In addition to the record of the reasons, the time periods of idle, broken-down and maintenance status are also recorded. Further, the person who makes the operational error(s) is recorded.

Therefore, when the machine is placed into non-available status, not only is the type of non-available status entered in the database, but also the reason why the machine is placed into the kind of the non-available status is recorded. In the present invention, various reasons why the machine has been placed into non-available status are put in the machine database. Therefore, effective information on each machine can be obtained from the database to realize the actual situation of the machine and efficiently manage the machine.

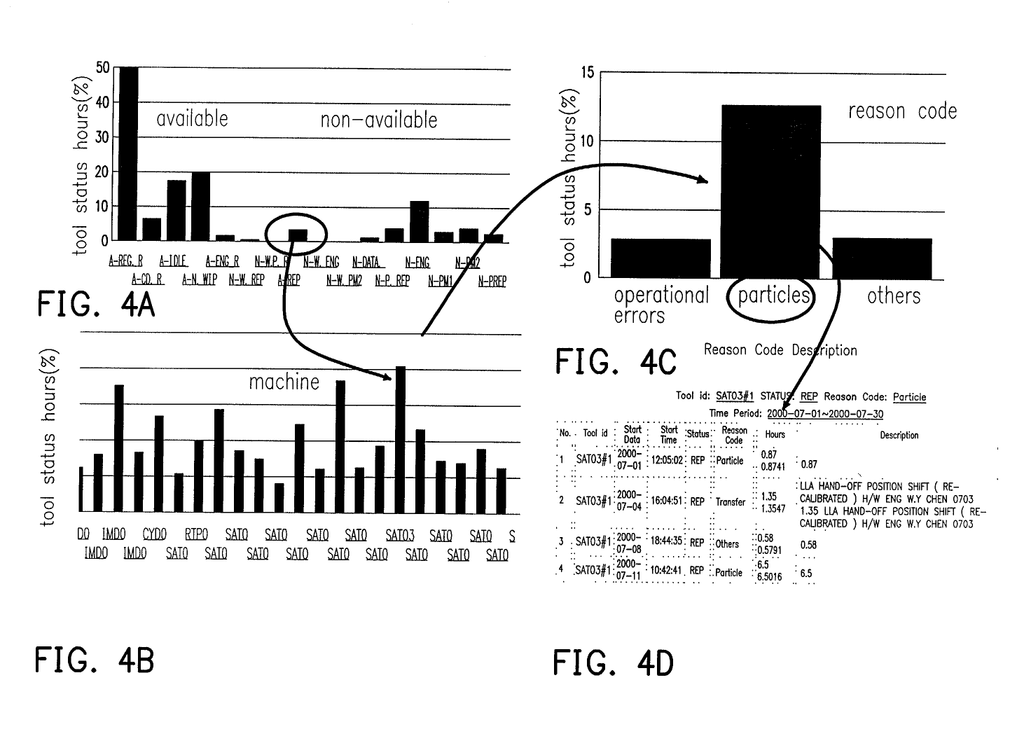

FIGS. 4A to 4D illustrate the use of the management system according to the present invention. The user here can be a production line operator, a process engineer, a system managing employee, or a supervisor. An interface used in the management system can be a graphic interface. In the embodiment shown in FIGS. 4A to 4D, the database is built through the process of FIG. 3.

In FIG. 4A, the management system displays available machines and the non-available machines in a certain period in a bar chart. The horizontal axis represents various types of available and non-available status. The vertical axis represents tool status hours (%). The left side of FIG. 4A shows available statuses including normal available status (A-REG R), idleness in available status (A-IDLE), engineering in available status (A-ENG), processing in available status (A-N WIP, wafer in process). Further, the tool status hours are shown with respect to each status. For example, a current normal available machine has tool status hour of 50%. The right side of FIG. 4A shows various types of non-available statuses and the related tool status hours. When a certain machine is to be used, the operator can obtain effective information from the Figure as indicated by a circle. Once the operator clicks some icons about “maintenance”, the management system shows the statistical graph of FIG. 4B, which illustrates maintenance-status among the non-available machines. In the prior art, the users only knew which machines were in non-available status, but had no idea about the reason. In other words, the reason could not be found from the record to modify the operation of the machine.

However, with the recording of the reason code according to the present invention, more detailed information about each certain machine can be provided. For example, the user can click a certain machine icon, for example Mode No. SAT03, to obtain the related statistical data of the SAT03 machine as shown in FIG. 4C. FIG. 4C illustrates the reasons why the SAT03 machine was placed into non-available maintenance status, including 3% operational errors, 13% particles and 3% others. It is clear from FIG. 4C that the machine was converted into non-available status mainly due to the particles.

Next, the user can get advanced information about the use status of the machine that was in need of maintenance due to the particles. FIG. 4D shows the status of the machine SAT 03#1. Column 1 shows the machine SAT 03#1 was maintained (REP) due to the existence of particles at 12:05:02, July the first, 2000, for a period of 0.87 hour. Therefore, the user or manager knows the maintenance period of the machine that was caused by the existence of particles. Besides, each record includes the timing, so that it is easy to know under which situation the machine is liable to be non-available.

The reason codes further include the reasons caused by operational errors. For example, if someone makes mistakes in operation that breaks down the machine or converts the machine into non-available status, this operational error should be entered in the database. It is easy to confirm whom the person is that often makes the machine become broken-down. Therefore, the manager can provide advanced education to make the operator more skilled, thereby increasing the operation efficiency and the performance of the machine.

The shop-floor managing employee can easily deal with the machines well by using the management system of the present invention. For example, it is easy to realize which machines, especially those used in the subsequent processes, are often in an idle status. The operator can find out the reason why the machine has been placed into idle status, and then efficiently control and handle the total machines for manufacturing. Thereby, the work efficiency can be enhanced to increase the throughput or the yield.

Furthermore, by using the management of the present invention, the reason why the machine has been placed into non-available status can be analyzed to effectively reduce the occurrence of non-available status.

The present invention has several advantages over the prior art. For example, not only are the types of non-available status of the machine recorded, but also the reasons why the machine has been converted into the non-available status are recorded as reason codes. Timing regarding the status is also recorded together with the respective reason. Thereby, the machine can be handled more efficiently. A graphic user interface can be further provided to immediately set up the information about the status of the machine. The user can also realize the status of the machine via the graphic user interface. Further, the management system of the present invention can connect the databases for all the machines in different manufacturing plants via the Internet, so that immediate information for each machine of the whole company can be provided.

It will be apparent to those skilled in the art that various modifications and variations can be made to the structure of the present invention without departing from the scope or spirit of the invention. In view of the forgoing, it is intended that the present invention cover modifications and variations of this invention provided they fall within the scope of the following claims and their equivalents.

What is claimed is:

1. A method of managing a manufacturing machine, comprising:
checking whether the machine is in available or non-available status;
if the machine is in non-available status, then detecting a type of the non-available status;
checking a reason why the machine has been placed into the type of the non-available status; and
recording the type of non-available status and the reason thereof.

2. The method of claim 1, wherein the reason is selected for a plurality of reason codes.

3. The method of claim 2, wherein the reason codes are previously determined.

4. The method of claim 1, further comprising a step of determining a type of the available status when the machine is in available status, and recording the type of the available status.

5. A method of managing a manufacturing machine, comprising:
building a reason list including a plurality of reason codes;
checking whether the machine is in available or non-available status;
if the machine is in non-available status, recording a type of the non-available status;
checking a reason resulting in the non-available status and corresponding the reason to a reason code; and
recording the reason code and corresponding the reason code to the type of the non-available status.

6. The method of claim 5, wherein reason codes are previously determined.

7. The method of claim 5, wherein a new code is added to the list once a new reason is generated.

8. The method of claim 5, further comprising of a step of determining a type of the available status when the machine is in available status, and recording the type of the available status.

9. A shop-floor management system used to manage situations of a plurality of machines via a database, the system comprising:
a reason code database having a plurality of reason codes respectively corresponding to reasons why the machines are placed into non-available statuses;
a machine database to record the statuses of the machines, wherein a column in the database includes at least one type of the machine, one type of non-available status and one reason code selected from the reason code database; and
a user interface coupling the reason code database to the machine database for a user to access the database.

10. The system of claim 9, wherein the reason codes in the reason code database are previously determined.

11. The system of claim 9, further comprising a manager interface coupled to the reason code database for changing of the reason code database.

12. The system of claim 9, wherein the user interface is a graphic user interface.

13. The system of claim 12, wherein the graphic user interface is coupled to a computer.
